(19) United States
(12) Patent Application Publication
(10) Pub. No.: US 2013/0009957 A1
(43) Pub. Date: Jan. 10, 2013

(54) IMAGE PROCESSING SYSTEM, IMAGE PROCESSING DEVICE, IMAGE PROCESSING METHOD, AND MEDICAL IMAGE DIAGNOSTIC DEVICE

(75) Inventor: Kazumasa ARAKITA, Nasushiobara-shi (JP)

(73) Assignees: Toshiba Medical Systems Corporation, Otawara-shi (JP); Kabushiki Kaisha Toshiba, Tokyo (JP)

(21) Appl. No.: 13/541,929

(22) Filed: Jul. 5, 2012

(30) Foreign Application Priority Data
Jul. 8, 2011 (JP) 2011-151732

(51) Int. Cl. G06T 17/00

(52) U.S. Cl. 345/424

(57) ABSTRACT

An image processing system according to an embodiment includes a stereoscopic display device, a determining unit, and a rendering processor. The stereoscopic display device displays a stereoscopic image that is capable of being viewed stereoscopically using a parallax image group generated from volume data as three-dimensional medical image data. The determining unit identifies positional variation of a predetermined moving substance in a stereoscopic image space as a space in which the stereoscopic image is displayed by the stereoscopic display device from positional variation of the moving substance in a real space in which a coordinate system of the stereoscopic image space is present and determines an operation content on the stereoscopic image based on the identified positional variation. The rendering processor performs rendering processing on the volume data in accordance with the operation content determined by the determining unit to generate a parallax image group newly.

### CROSS-REFERENCE TO RELATED APPLICATIONS

This application is based upon and claims the benefit of priority from Japanese Patent Application No. 2011-151732, filed on Jul. 8, 2011; the entire contents of which are incorporated herein by reference.

### FIELD

Embodiments described herein relate generally to an image processing system, an image processing device, an image processing method, and a medical image diagnostic device.

### BACKGROUND

In the past, there has been known a technique of causing two parallax images, captured from two points of view, to be displayed on a monitor so that a user who uses a dedicated device such as stereoscopic view glasses can view a stereoscopic image. Further, in recent years, there has been developed a technique of causing multiple parallax images (for example, nine parallax images), captured from a plurality of points of view, to be displayed on a monitor using a light beam controller such as a lenticular lens so that the user can view a stereoscopic image with the naked eyes. A plurality of images to be displayed on a monitor that can be viewed stereoscopically are generated by estimating depth information of an image shot from one viewpoint and performing image processing using the estimated information in some cases.

As medical image diagnostic devices such as X-ray computed tomography (CT) devices, magnetic resonance imaging (MRI) devices, and ultrasonography devices, devices that can generate three-dimensional (3D) medical image data (hereinafter, volume data) have been put into practice. Such a medical image diagnostic device generates a flat image for display by executing various pieces of image processing on volume data and displays the generated flat image on a general-purpose monitor. For example, the medical image diagnostic device executes volume rendering processing on volume data so as to generate a two-dimensional rendering image on which three-dimensional information for a subject has been reflected, and displays the generated rendering image on the general-purpose monitor.

### BRIEF DESCRIPTION OF THE DRAWINGS

FIG. 1 is a diagram for explaining a configuration example of an image processing system according to a first embodiment;

FIG. 2A and FIG. 2B are views for explaining an example of a stereoscopic display monitor on which stereoscopic display is performed using two-parallax images;

FIG. 3 is a view for explaining an example of a stereoscopic display monitor on which stereoscopic display is performed using nine-parallax images;

FIG. 4 is a diagram for explaining a configuration example of a workstation in the first embodiment;

FIG. 5 is a diagram for explaining a configuration example of a rendering processor as illustrated in FIG. 4;

FIG. 6 is a view for explaining an example of volume rendering processing in the first embodiment;

FIG. 7 is a view for explaining an example of processing by the image processing system in the first embodiment;

FIG. 8 is a diagram for explaining a configuration example of a controller in the first embodiment;

FIG. 9 is a view illustrating an example of a correspondence relationship between a stereoscopic image space and a volume data space;

FIG. 10 is a view for explaining an example of processing by the controller in the first embodiment;

FIG. 11 is a view for explaining an example of processing by the controller in the first embodiment;

FIG. 12 is a flowchart illustrating an example of a processing flow by the workstation in the first embodiment;

FIG. 13 is a view for explaining a modification of the first embodiment;

FIG. 14 is a view for explaining another modification of the first embodiment; and

FIG. 15 is a view for explaining still another modification of the first embodiment.

### DETAILED DESCRIPTION

An image processing system according to an embodiment includes a stereoscopic display device, a determining unit, and a rendering processor. The stereoscopic display device displays a stereoscopic image that can be viewed stereoscopically using a parallax image group generated from volume data as three-dimensional medical image data. The determining unit identifies positional variation of a predetermined moving substance in a stereoscopic image space from positional variation of the moving substance in a real space, and determines an operation content on the stereoscopic image based on the identified positional variation. Note that the stereoscopic image space is a space in which the stereoscopic image is displayed by the stereoscopic display device and a coordinate system of the stereoscopic image space is present in the real space. The rendering processor performs rendering processing on the volume data in accordance with the operation content determined by the determining unit to generate a parallax image group newly.

Hereinafter, embodiments of the image processing system, an image processing device, an image processing method, and a medical image diagnostic device are described in detail with reference to accompanying drawings. It is to be noted that an image processing system including a workstation having a function as an image processing device is described as an embodiment, hereinafter. Here, the terminology used in the following embodiments is described. A “parallax image group” refers to an image group which is generated by performing a volume rendering process on volume data while moving a point-of-view position by a predetermined parallactic angle at a time. In other words, the “parallax image group” is configured with a plurality of “parallax images” having different “point-of-view positions.” Further, a “parallactic angle” refers to an angle determined by an adjacent point-of-view position among point-of-view positions set to generate the “parallax image group” and a predetermined position in a space (the center of a space) represented by volume data. Further, a “parallax number” refers to the number of “parallax images” necessary to implement a stereoscopic view by a stereoscopic display monitor. Further, a “nine-parallax image” described in the following refers to a “parallax image group” consisting of nine “parallax images.” Furthermore, a “two-parallax image” described in the following refers to a “parallax image group” consisting of two “parallax images.”

### First Embodiment

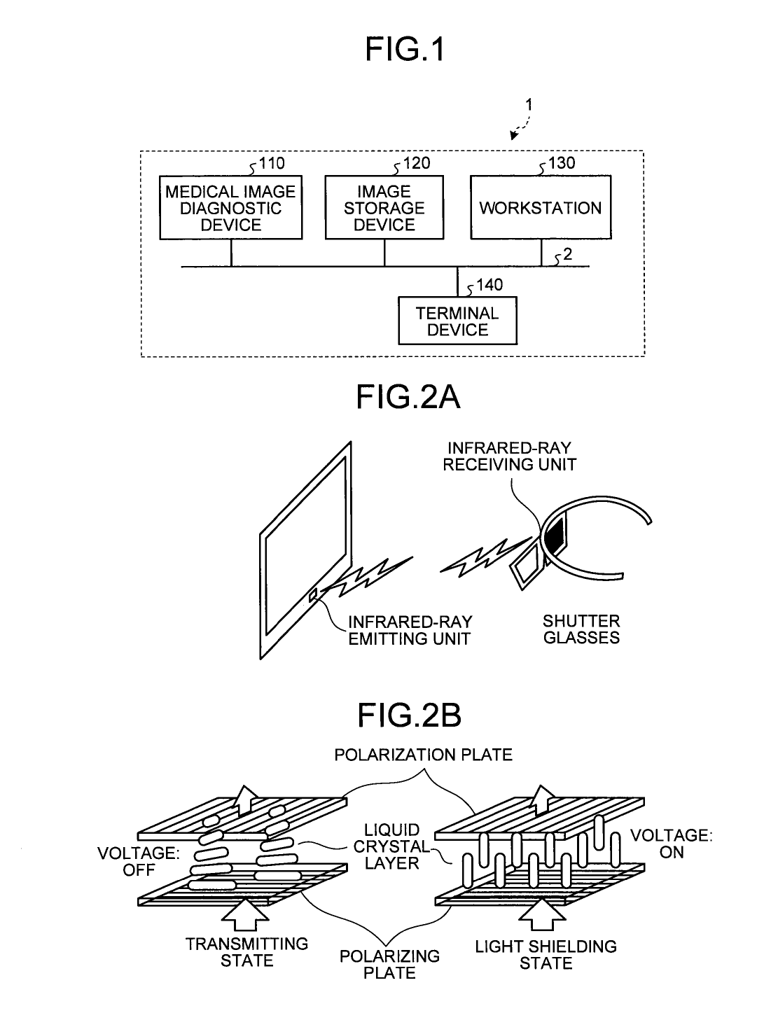

First, a configuration example of an image processing system according to a first embodiment will be described. FIG. 1 is a diagram for describing a configuration example of an image processing system according to the first embodiment.

As illustrated in FIG. 1, an image processing system 1 according to the first embodiment includes a medical image diagnostic device 110, an image storage device 120, a workstation 130, and a terminal device 140. The respective devices illustrated in FIG. 1 are connected to directly or indirectly communicate one another, for example, via a hospital Local Area Network (LAN) 2 installed in a hospital. For example, when a Picture Archiving and Communication System (PACS) is introduced into the image processing system 1, the respective devices exchange a medical image or the like with one another according to a Digital Imaging and Communications in Medicine (DICOM) standard.

The image processing system 1 provides an observer, who works in the hospital such as a doctor or a laboratory technician, with a stereoscopic image which is an image stereoscopically viewable to the observer by generating a parallax image group based on volume data which is 3D medical image data generated by the medical image diagnostic device 110 and then causing the parallax image group to be displayed on a monitor with a stereoscopic view function. Specifically, in the first embodiment, the workstation 130 performs a variety of image processing on volume data and generates a parallax image group. Each of the workstation 130 and the terminal device 140 includes a monitor with a stereoscopic view function, and displays a stereoscopic image to a user by displaying the parallax image group generated by the workstation 130 through the monitor. The image storage device 120 stores volume data generated by the medical image diagnostic device 110 and the parallax image group generated by the workstation 130. For example, the workstation 130 or the terminal device 140 acquires the volume data or the parallax image group from the image storage device 120, executes arbitrary image processing on the acquired volume data or the acquired parallax image group, and causes the parallax image group to be displayed on the monitor. The respective devices will be described below in order.

The medical image diagnostic device 110 is an X-ray diagnostic device, an X-ray Computed Tomography (CT) device, a Magnetic Resonance Imaging (MRI) device, an ultrasonic diagnostic device, a Single Photon Emission Computed Tomography (SPECT) device, a Positron Emission computed Tomography (PET) device, a SPECT-CT device in which a SPECT device is integrated with an X-ray CT device, a PET-CT device in which a PET device is integrated with an X-ray CT device, a device group thereof, or the like. The medical image diagnostic device 110 according to the first embodiment can generate 3D medical image data (volume data).

Specifically, the medical image diagnostic device 110 according to the first embodiment captures a subject, and generates volume data. For example, the medical image diagnostic device 110 generates volume data such that it collects data such as projection data or an MR signal by capturing a subject, and then reconstructs medical image data including a plurality of axial planes along a body axis direction of a subject based on the collected data. For example, when the medical image diagnostic device 110 reconstructs medical image data of 500 axial planes, a medical image data group of 500 axial planes is used as volume data. Alternatively, projection data or an MR signal of a subject captured by the medical image diagnostic device 110 may be used as volume data.

The medical image diagnostic device 110 according to the first embodiment transmits the generated volume data to the image storage device 120. When the medical image diagnostic device 110 transmits the volume data to the image storage device 120, the medical image diagnostic device 110 transmits supplementary information such as a patient ID identifying a patient, an inspection ID identifying an inspection, a device ID identifying the medical image diagnostic device 110, and a series ID identifying single shooting by the medical image diagnostic device 110, for example.

The image storage device 120 is a database that stores a medical image. Specifically, the image storage device 120 according to the first embodiment receives the volume data from the medical image diagnostic device 110, and stores the received volume data in a predetermined storage unit. Further, in the first embodiment, the workstation 130 generates a parallax image group based on the volume data, and transmits the generated parallax image group to the image storage device 120. Thus, the image storage device 120 stores the parallax image group transmitted from the workstation 130 in a predetermined storage unit. Further, in the present embodiment, the workstation 130 capable of storing a large amount of images may be used, and in this case, the image storage device 120 illustrated in FIG. 1 may be incorporated with the workstation 130 illustrated in FIG. 1. In other words, in the present embodiment, the volume data or the parallax image group may be stored in the workstation 130.

Further, in the first embodiment, the volume data or the parallax image group stored in the image storage device 120 is stored in association with the patient ID, the inspection ID, the device ID, the series ID, and the like. Thus, the workstation 130 or the terminal device 140 performs a search using the patient ID, the inspection ID, the device ID, the series ID, or the like, and acquires necessary volume data or a necessary parallax image group from the image storage device 120.

The workstation 130 is an image processing apparatus that performs image processing on a medical image. Specifically, the workstation 130 according to the first embodiment performs various rendering processes on the volume data acquired from the image storage device 120, and generates a parallax image group.

Further, the workstation 130 according to the first embodiment includes a monitor (which is referred to as a “stereoscopic display monitor” or “stereoscopic image display device”) capable of displaying a stereoscopic image as a display unit. The workstation 130 generates a parallax image group and causes the generated parallax image group to be displayed on the stereoscopic display monitor. Thus, an operator of the workstation 130 can perform an operation of generating a parallax image group while checking a stereoscopically viewable stereoscopic image displayed on the stereoscopic display monitor.

Further, the workstation 130 transmits the generated parallax image group to the image storage device 120 or the terminal device 140. The workstation 130 transmits the supplementary information such as the patient ID, the inspection ID, the device ID, and the series ID, for example, when transmitting the parallax image group to the image storage device 120 or the terminal device 140. As supplementary information transmitted when the parallax image group is transmitted to the image storage device 120, supplementary information related to the parallax image group is further included. Examples of the supplementary information related to the parallax image group include the number of parallax images (for example, “9”) and the resolution of a parallax image (for example, “466×350 pixels.”

The terminal device 140 is a device that allows a doctor or a laboratory technician who works in the hospital to view a medical image. Examples of the terminal device 140 include a Personal Computer (PC), a tablet-type PC, a Personal Digital Assistant (PDA), and a portable telephone, which are operated by a doctor or a laboratory technician who works in the hospital. Specifically, the terminal device 140 according to the first embodiment includes a stereoscopic display monitor as a display unit. Further, the terminal device 140 acquires a parallax image group from the image storage device 120, and causes the acquired parallax image group to be displayed on the stereoscopic display monitor. As a result, a doctor or a laboratory technician who is an observer can view a stereoscopically viewable medical image. Alternatively, the terminal device 140 may be an arbitrary information processing terminal connected with a stereoscopic display monitor as an external device.

Here, the stereoscopic display monitor included in the workstation 130 or the terminal device 140 will be described. A general-purpose monitor which is currently most widely used two dimensionally displays a two-dimensional (2D) image and hardly performs a 3D display on a 2D image. If an observer desires a stereoscopic view to be displayed on the general-purpose monitor, a device that outputs an image to the general-purpose monitor needs to parallel-display a two-parallax image stereoscopically viewable to an observer through a parallel method or an intersection method. Alternatively, a device that outputs an image to the general-purpose monitor needs to display an image stereoscopically viewable to an observer through a color-complementation method using glasses in which a red cellophane is attached to a left-eye portion and a blue cellophane is attached to a right-eye portion.

Meanwhile, there are stereoscopic display monitors that allow a two-parallax image (which is also referred to as a “binocular parallax image”) to be stereoscopically viewed using a dedicated device such as stereoscopic glasses.

FIGS. 2A and 2B are diagrams for describing an example of a stereoscopic display monitor that performs a stereoscopic display based on a two-parallax image. In the example illustrated in FIGS. 2A and 2B, the stereoscopic display monitor performs a stereoscopic display by a shutter method, and shutter glasses are used as stereoscopic glasses worn by an observer who observes the monitor. The stereoscopic display monitor alternately outputs a two-parallax image in the monitor. For example, the monitor illustrated in FIG. 2A alternately outputs a left-eye image and a right-eye image with 120 Hz. As illustrated in FIG. 2A, the monitor includes an infrared-ray output unit, and controls an output of an infrared ray according to a timing at which images are switched.

The infrared ray output from the infrared-ray output unit is received by an infrared-ray receiving unit of the shutter glasses illustrated in FIG. 2A. A shutter is mounted to each of right and left frames of the shutter glasses, and the shutter glasses alternately switch a transmission state and a light shielding state of the right and left shutters according to a timing at which the infrared-ray receiving unit receives the infrared ray. A switching process of a transmission state and a light shielding state of the shutter will be described below.

As illustrated in FIG. 2B, each shutter includes an incident side polarizing plate and an output side polarizing plate, and further includes a liquid crystal layer disposed between the incident side polarizing plate and the output side polarizing plate. The incident side polarizing plate and the output side polarizing plate are orthogonal to each other as illustrated in FIG. 2B. Here, as illustrated in FIG. 2B, in an OFF state in which a voltage is not applied, light has passed through the incident side polarizing plate rotates at 90° due to an operation of the liquid crystal layer, and passes through the output side polarizing plate. In other words, the shutter to which a voltage is not applied becomes a transmission state.

Meanwhile, as illustrated in FIG. 2B, in an ON state in which a voltage is applied, a polarization rotation operation caused by liquid crystal molecules of the liquid crystal layer does not work, and thus light having passed through the incident side polarizing plate is shielded by the output side polarizing plate. In other words, the shutter to which a voltage is applied becomes a light shielding state.

In this regard, for example, the infrared-ray output unit outputs the infrared ray during a time period in which the left-eye image is being displayed on the monitor. Then, during a time period in which the infrared ray is being received, the infrared-ray receiving unit applies a voltage to the right-eye shutter without applying a voltage to the left-eye shutter. Through this operation, as illustrated in FIG. 2A, the right-eye shutter becomes the light shielding state, and the left-eye shutter becomes the transmission state, so that the left-eye image is incident to the left eye of the observer. Meanwhile, during a time period in which the right-eye image is being displayed on the monitor, the infrared-ray output unit stops an output of the infrared ray. Then, during a time period in which the infrared ray is not being received, the infrared-ray receiving unit applies a voltage to the left-eye shutter without applying a voltage to the right-eye shutter. Through this operation, the left-eye shutter becomes the light shielding state, and the right-eye shutter becomes the transmission state, so that the right-eye image is incident to the right eye of the observer. As described above, the stereoscopic display monitor illustrated in FIGS. 2A and 2B causes an image stereoscopically viewable to the observer to be displayed by switching an image to be displayed on the monitor in conjunction with the state of the shutter. A monitor employing a polarizing glasses method other than the shutter method is also known as the stereoscopic display monitor that allows a two-parallax image to be stereoscopically viewed.

Further, a stereoscopic display monitor that allows an observer to stereoscopically view a multi-parallax image with the naked eyes such as a nine-parallax image using a light beam controller such as a lenticular lens has been recently put to practical. This kind of stereoscopic display monitor makes a stereoscopic view possible by binocular parallax, and further makes a stereoscopic view possible by kinematic parallax in which an observed video changes with the movement of a point of view of an observer.

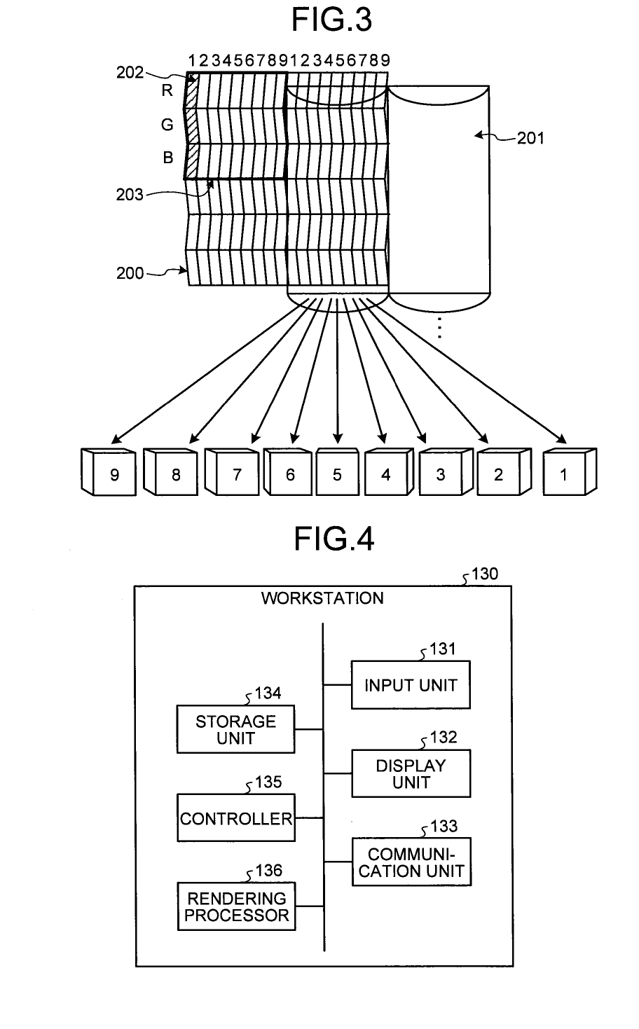

FIG. 3 is a diagram for describing an example of a stereoscopic display monitor that performs a stereoscopic display based on a nine-parallax image. In the stereoscopic display monitor illustrated in FIG. 3, a light beam controller is arranged in front of a planar display surface 200 such as a liquid crystal panel. For example, in the stereoscopic display monitor illustrated in FIG. 3, a vertical lenticular sheet 201 including an optical opening that extends in a vertical direction is attached to the front surface of the display surface 200 as the light beam controller. In the example illustrated in FIG. 3, the vertical lenticular sheet 201 is attached such that a convex portion thereof serves as the front surface, but the vertical lenticular sheet 201 may be attached such that a convex portion thereof faces the display surface 200.

As illustrated in FIG. 3, in the display surface 200, an aspect ratio is 3:1, and pixels 202 each of which includes three sub-pixels of red (R), green (G), and blue (B) arranged in a longitudinal direction are arranged in the form of a matrix. The stereoscopic display monitor illustrated in FIG. 3 converts a nine-parallax image including nine images into an interim image arranged in a predetermined format (for example, in a lattice form), and outputs the interim image to the display surface 200. In other words, the stereoscopic display monitor illustrated in FIG. 3 allocates nine pixels at the same position in the nine-parallax image to the pixels 202 of nine columns, respectively, and then performs an output. The pixels 202 of nine columns become a unit pixel group 203 to simultaneously display nine images having different point-of-view positions.

The nine-parallax image simultaneously output as the unit pixel group 203 in the display surface 200 is radiated as parallel light through a Light Emitting Diode (LED) backlight, and further radiated in multiple directions through the vertical lenticular sheet 201. As light of each pixel of the nine-parallax image is radiated in multiple directions, lights incident to the left eye and the right eye of the observer change in conjunction with the position (the position of the point of view) of the observer. In other words, depending on an angle at which the observer views, a parallax image incident to the right eye differs in a parallactic angle from a parallax image incident to the left eye. Through this operation, the observer can stereoscopically view a shooting target, for example, at each of nine positions illustrated in FIG. 3. For example, the observer can stereoscopically view, in a state in which the observer directly faces a shooting target, at the position of “5” illustrated in FIG. 3, and can stereoscopically view, in a state in which a direction of a shooting target is changed, at the positions other than “5” illustrated in FIG. 3. The stereoscopic display monitor illustrated in FIG. 3 is merely an example. The stereoscopic display monitor that displays the nine-parallax image may include a horizontal stripe liquid crystal of “RRR---, GGG---, and BBB---” as illustrated in FIG. 3 or may include a vertical stripe liquid crystal of “RGBRGB---.” Further, the stereoscopic display monitor illustrated in FIG. 3 may be of a vertical lens type in which a lenticular sheet is vertical as illustrated in FIG. 3 or may be of an oblique lens type in which a lenticular sheet is oblique.

The configuration example of the image processing system 1 according to the first embodiment has been briefly described so far. An application of the image processing system 1 described above is not limited to a case in which the PACS is introduced. For example, the image processing system 1 is similarly applied even to a case in which an electronic chart system for managing an electronic chart with a medical image attached thereto is introduced. In this case, the image storage device 120 serves as a database for managing an electronic chart. Further, for example, the image processing system 1 is similarly applied even to a case in which a Hospital Information System (HIS) or Radiology Information System (RIS) is introduced. Further, the image processing system 1 is not limited to the above-described configuration example. A function or an assignment of each device may be appropriately changed according to an operation form.

Next, a configuration example of a workstation according to the first embodiment will be described with reference to FIG. 4. FIG. 4 is a diagram for describing a configuration example of a workstation according to the first embodiment. In the following, a “parallax image group” refers to an image group for a stereoscopic view generated by performing a volume rendering process on volume data. Further, a “parallax image” refers to each of images that configure the “parallax image group.” In other words, the “parallax image group” is configured with a plurality of “parallax images” having different point-of-view positions.

The workstation 130 according to the first embodiment is a high-performance computer appropriate to image processing or the like, and includes an input unit 131, a display unit 132, a communication unit 133, a storage unit 134, a control unit 135, and a rendering processing unit 136 as illustrated in FIG. 4. In the following, a description will be made in connection with an example in which the workstation 130 is a high-performance computer appropriate to image processing or the like. However, the workstation 130 is not limited to this example, and may be an arbitrary information processing device. For example, the workstation 130 may be an arbitrary personal computer.

The input unit 131 includes a mouse, a keyboard, a trackball, or the like, and receives various operations which an operator has input on the workstation 130. Specifically, the input unit 131 according to the first embodiment receives an input of information used to acquire volume data which is a target of the rendering process from the image storage device 120. For example, the input unit 131 receives an input of the patient ID, the inspection ID, the device ID, the series ID, or the like. Further, the input unit 131 according to the first embodiment receives an input of a condition (hereinafter, referred to as a “rendering condition”) related to the rendering process.

The display unit 132 includes a liquid crystal panel serving as a stereoscopic display monitor, and displays a variety of information. Specifically, the display unit 132 according to the first embodiment displays a Graphical User Interface (GUI), which is used to receive various operations from the operator, a parallax image group, or the like. The communication unit 133 includes a Network Interface Card (NIC) or the like and performs communication with other devices.

The storage unit 134 includes a hard disk, a semiconductor memory device, or the like, and stores a variety of information. Specifically, the storage unit 134 according to the first embodiment stores the volume data acquired from the image storage device 120 through the communication unit 133. Further, the storage unit 134 according to the first embodiment stores volume data which is under the rendering process, a parallax image group generated by the rendering process, or the like.

The control unit 135 includes an electronic circuit such as a Central Processing Unit (CPU), a Micro Processing Unit (MPU), or a Graphics Processing Unit (GPU) or an integrated circuit such as an Application Specific Integrated Circuit (ASIC) or a Field Programmable Gate Array (FPGA). The control unit 135 controls the workstation 130 in general.

For example, the control unit 135 according to the first embodiment controls a display of the GUI on the display unit 132 or a display of a parallax image group. Further, for example, the control unit 135 controls transmission/reception of the volume data or the parallax image group to/from the image storage device 120, which is performed through the communication unit 133. Further, for example, the control unit 135 controls the rendering process performed by the rendering processing unit 136. Further, for example, the control unit 135 controls an operation of reading volume data from the storage unit 134 or an operation of storing a parallax image group in the storage unit 134.

The rendering processing unit 136 performs various rendering processes on volume data acquired from the image storage device 120 under control of the control unit 135, and thus generates a parallax image group. Specifically, the rendering processing unit 136 according to the first embodiment reads volume data from the storage unit 134, and first performs pre-processing on the volume data. Next, the rendering processing unit 136 performs a volume rendering process on the pre-processed volume data, and generates a parallax image group. Subsequently, the rendering processing unit 136 generates a 2D image in which a variety of information (a scale, a patient name, an inspection item, and the like) is represented, and generates a 2D output image by superimposing the 2D image on each parallax image group. Then, the rendering processing unit 136 stores the generated parallax image group or the 2D output image in the storage unit 134. Further, in the first embodiment, the rendering process refers to the entire image processing performed on the volume data, and the volume rendering process a process of generating a 2D image in which 3D information is reflected during the rendering process. For example, the medical image generated by the rendering process corresponds to a parallax image.

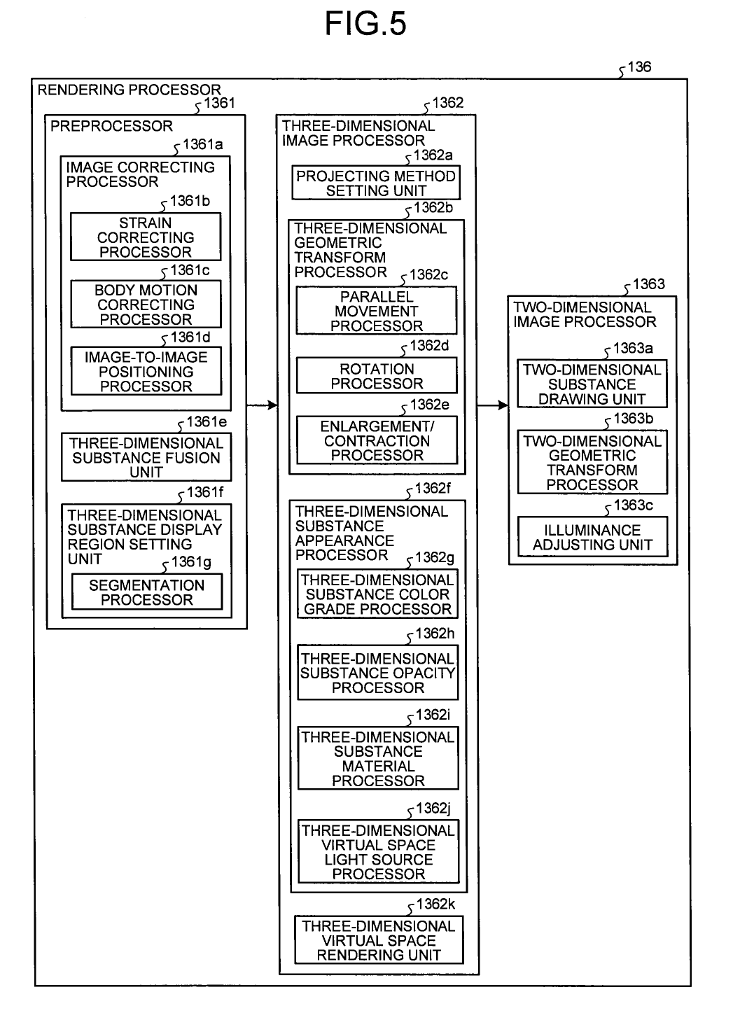

FIG. 5 is a diagram for describing a configuration example of the rendering processing unit illustrated in FIG. 4. As illustrated in FIG. 5, the rendering processing unit 136 includes a pre-processing unit 1361, a 3D image processing unit 1362, and a 2D image processing unit 1363. The pre-processing unit 1361 performs pre-processing on volume data. The 3D image processing unit 1362 generates a parallax image group from pre-processed volume data. The 2D image processing unit 1363 generates a 2D output image in which a variety of information is superimposed on a parallax image group. The respective units will be described below in order.

The pre-processing unit 1361 is a processing unit that performs a variety of pre-processing when performing the rendering process on volume data, and includes an image correction processing unit 1361a, a 3D object fusion unit 1361e, and a 3D object display area setting unit 1361f.

The image correction processing unit 1361a is a processing unit that performs an image correction process when processing two types of volume data as one volume data, and includes a distortion correction processing unit 1361b, a body motion correction processing unit 1361c, and an inter-image positioning processing unit 1361d as illustrated in FIG. 5. For example, the image correction processing unit 1361a performs an image correction process when processing volume data of a PET image generated by a PET-CT device and volume data of an X-ray CT image as one volume data. Alternatively, the image correction processing unit 1361a performs an image correction process when processing volume data of a T1-weighted image and volume data of a T2-weighted image which are generated by an MRI device as one volume data.

Further, the distortion correction processing unit 1361b corrects distortion of individual volume data caused by a collection condition at the time of data collection by the medical image diagnostic device 110. Further, the body motion correction processing unit 1361c corrects movement caused by body motion of a subject during a data collection time period used to generate individual volume data. Further, the inter-image positioning processing unit 1361d performs positioning (registration), for example, using a cross correlation method between two pieces of volume data which have been subjected to the correction processes by the distortion correction processing unit 1361b and the body motion correction processing unit 1361c.

The 3D object fusion unit 1361e performs the fusion of a plurality of volume data which have been subjected to the positioning by the inter-image positioning processing unit 1361d. Further, the processes performed by the image correction processing unit 1361a and the 3D object fusion unit 1361e may not be performed when the rendering process is performed on single volume data.

The 3D object display area setting unit 1361f is a processing unit that sets a display area corresponding to a display target organ designated by an operator, and includes a segmentation processing unit 1361g. The segmentation processing unit 1361g is a processing unit that extracts an organ, such as a heart, a lung, or a blood vessel, which is designated by the operator, for example, by an area extension technique based on a pixel value (voxel value) of volume data.

Further, the segmentation processing unit 1361g does not perform the segmentation process when a display target organ has not been designated by the operator. Further, the segmentation processing unit 1361g extracts a plurality of corresponding organs when a plurality of display target organs are designated by the operator. Further, the process performed by the segmentation processing unit 1361g may be re-executed at a fine adjustment request of the operator who has referred to a rendering image.

The 3D image processing unit 1362 performs the volume rendering process on the pre-processed volume data which has been subjected to the process performed by the pre-processing unit 1361. As processing units for performing the volume rendering process, the 3D image processing unit 1362 includes a projection method setting unit 1362a, a 3D geometric transform processing unit 1362b, a 3D object appearance processing unit 1362f, and a 3D virtual space rendering unit 1362k.

The projection method setting unit 1362a determines a projection method for generating a parallax image group. For example, the projection method setting unit 1362a determines whether the volume rendering process is to be executed using a parallel projection method or a perspective projection method.

The 3D geometric transform processing unit 1362b is a processing unit that determines information necessary to perform 3D geometric transform on volume data which is to be subjected to the volume rendering process, and includes a parallel shift processing unit 1362c, a rotation processing unit 1362d, and a scaling processing unit 1362e. The parallel shift processing unit 1362c is a processing unit that determines a shift amount to shift volume data in parallel when a point-of-view position is shifted in parallel at the time of the volume rendering process. The rotation processing unit 1362d is a processing unit that determines a movement amount for rotationally moving volume data when a point-of-view position is rotationally moved at the time of the volume rendering process. Further, the scaling processing unit 1362e is a processing unit that determines an enlargement ratio or a reduction ratio of volume data when it is requested to enlarge or reduce a parallax image group.

The 3D object appearance processing unit 1362f includes a 3D object color processing unit 1362g, a 3D object opacity processing unit 1362h, a 3D object quality-of-material processing unit 1362i, and a 3D virtual space light source processing unit 1362j. The 3D object appearance processing unit 1362f performs a process of determining a display form of a parallax image group to be displayed through the above processing units, for example, according to the operator's request.

The 3D object color processing unit 1362g is a processing unit that determines a color colored to each area segmented from volume data. The 3D object opacity processing unit 1362h is a processing unit that determines opacity of each voxel configuring each area segmented from volume data. In volume data, an area behind an area having opacity of “100%” is not represented in a parallax image group. Further, in volume data, an area having opacity of “0%” is not represented in a parallax image group.

The 3D object quality-of-material processing unit 1362i is a processing unit that determines the quality of a material of each area segmented from volume data and adjusts the texture when the area is represented. The 3D virtual space light source processing unit 1362j is a processing unit that determines the position or the type of a virtual light source installed in a 3D virtual space when the volume rendering process is performed on volume data. Examples of the type of a virtual light source include a light source that emits a parallel beam from infinity and a light source that emits a radial beam from a point of view.

The 3D virtual space rendering unit 1362k performs the volume rendering process on volume data, and generates a parallax image group. Further, the 3D virtual space rendering unit 1362k uses a variety of information, which is determined by the projection method setting unit 1362a, the 3D geometric transform processing unit 1362b, and the 3D object appearance processing unit 1362f, as necessary when the volume rendering process is performed.

Here, the volume rendering process performed by the 3D virtual space rendering unit 1362k is performed according to the rendering condition. For example, the parallel projection method or the perspective projection method may be used as the rendering condition. Further, for example, a reference point-of-view position, a parallactic angle, and a parallax number may be used as the rendering condition. Further, for example, a parallel shift of a point-of-view position, a rotational movement of a point-of-view position, an enlargement of a parallax image group, and a reduction of a parallax image group may be used as the rendering condition. Further, for example, a color colored, transparency, the texture, the position of a virtual light source, and the type of virtual light source may be used as the rendering condition. The rendering condition may be input by the operator through the input unit 131 or may be initially set. In either case, the 3D virtual space rendering unit 1362k receives the rendering condition from the control unit 135, and performs the volume rendering process on volume data according to the rendering condition. Further, at this time, the projection method setting unit 1362a, the 3D geometric transform processing unit 1362b, and the 3D object appearance processing unit 1362f determine a variety of necessary information according to the rendering condition, and thus the 3D virtual space rendering unit 1362k generates a parallax image group using a variety of information determined.

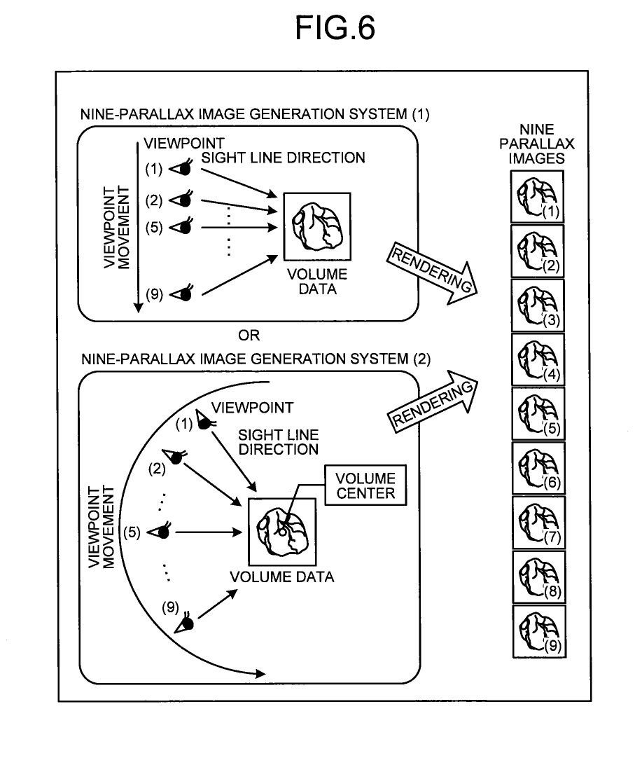

FIG. 6 is a diagram for describing an example of the volume rendering process according to the first embodiment. For example, let us assume that the 3D virtual space rendering unit 1362k receives the parallel projection method as the rendering condition, and further receives a reference point-of-view position (5) and a parallactic angle “1°” as illustrated in a “nine-parallax image generating method (1)” of FIG. 6. In this case, the 3D virtual space rendering unit 1362k shifts the position of a point of view to (1) to (9) in parallel so that the parallactic angle can be changed by “1°”, and generates nine parallax images between which the parallactic angle (an angle in a line-of-sight direction) differs from each other by 1° by the parallel projection method. Further, when the parallel projection method is performed, the 3D virtual space rendering unit 1362k sets a light source that emits a parallel beam in a line-of-sight direction from infinity.

Alternatively, the 3D virtual space rendering unit 1362k receives the perspective projection method as the rendering condition, and further receives a reference point-of-view position (5) and a parallactic angle “1°” as illustrated in a “nine-parallax image generating method (2)” of FIG. 6. In this case, the 3D virtual space rendering unit 1362k rotationally moves the position of a point of view to (1) to (9) so that the parallactic angle can be changed by “1°” centering on the center (gravity center) of volume data, and generates nine parallax images between which the parallactic angle differs from each other by 1° by the perspective projection method. Further, when the perspective projection method is performed, the 3D virtual space rendering unit 1362k sets a point light source or a surface light source, which three-dimensionally emits light in a radial manner centering on a line-of-sight direction, at each point of view. Further, when the perspective projection method is performed, the points of view (1) to (9) may be parallel-shifted according to the rendering condition.

Further, the 3D virtual space rendering unit 1362k may perform the volume rendering process using the parallel projection method and the perspective projection method together by setting a light source that two-dimensionally emits light in a radial manner centering on the line-of-sight direction on a longitudinal direction of a volume rendering image to display, and emits a parallel beam in the line-of-sight direction from infinity on a transverse direction of a volume rendering image to display.

The nine parallax images generated in the above-described way configure a parallax image group. In the first embodiment, for example, the nine parallax images are converted into interim images arranged in a predetermined format (for example, a lattice form) by the control unit 135, and then output to the display unit 132 serving as the stereoscopic display monitor. At this time, the operator of the workstation 130 can perform an operation of generating a parallax image group while checking a stereoscopically viewable medical image displayed on the stereoscopic display monitor.

The example of FIG. 6 has been described in connection with the case in which the projection method, the reference point-of-view position, and the parallactic angle are received as the rendering condition. However, similarly even when any other condition is received as the rendering condition, the 3D virtual space rendering unit 1362k generates the parallax image group while reflecting each rendering condition.

Further, the 3D virtual space rendering unit 1362k further has a function of performing a Multi Planer Reconstruction (MPR) technique as well as the volume rendering and reconstructing an MPR image from volume data. The 3D virtual space rendering unit 1362k further has a function of performing a “curved MPR” and a function of performing “intensity projection.”

Subsequently, the parallax image group which the 3D image processing unit 1362 has generated based on the volume data is regarded as an underlay. Then, an overlay in which a variety of information (a scale, a patient name, an inspection item, and the like) is represented is superimposed on the underlay, so that a 2D output image is generated. The 2D image processing unit 1363 is a processing unit that performs image processing on the overlay and the underlay and generates a 2D output image, and includes a 2D object rendering unit 1363a, a 2D geometric transform processing unit 1363b, and a brightness adjusting unit 1363c as illustrated in FIG. 5. For example, in order to reduce a load required in a process of generating a 2D output image, the 2D image processing unit 1363 generates nine 2D output images by superimposing one overlay on each of nine parallax images (underlays). In the following, an underlay on which an overlay is superimposed may be referred to simply as a “parallax image.”

The 2D object rendering unit 1363a is a processing unit that renders a variety of information represented on the overlay. The 2D geometric transform processing unit 1363b is a processing unit that parallel-shifts or rotationally moves the position of a variety of information represented on the overlay, or enlarges or reduces a variety of information represented on the overlay.

The brightness adjusting unit 1363c is a processing unit that performs a brightness converting process. For example, the brightness adjusting unit 1363c adjusts brightness of the overlay and the underlay according to an image processing parameter such as gradation of a stereoscopic display monitor of an output destination, a window width (WW), or a window level (WL).

For example, the control unit 135 stores the 2D output image generated as described above in the storage unit 134, and then transmits the 2D output image to the image storage device 120 through the communication unit 133. Then, for example, the terminal device 140 acquires the 2D output image from the image storage device 120, converts the 2D output image into an interim image arranged in a predetermined format (for example, a lattice form), and displays the interim image on the stereoscopic display monitor. Further, for example, the control unit 135 stores the 2D output image in the storage unit 134, then transmits the 2D output image to the image storage device 120 through the communication unit 133, and transmits the 2D output image to the terminal device 140. Then, the terminal device 140 converts the 2D output image transmitted from the workstation 130 into the interim image arranged in a predetermined format (for example, a lattice form), and causes the interim image to be displayed on the stereoscopic display monitor. Through this operation, a doctor or a laboratory technician who uses the terminal device 140 can view a stereoscopically viewable medical image in a state in which a variety of information (a scale, a patient name, an inspection item, and the like) is represented.

Thus, the above-described stereoscopic display monitor displays a parallax image group so as to provide a stereoscopic image that can be viewed stereoscopically by an observer. The observer performs various types of operations on the stereoscopic image using a pointing device such as a mouse in some cases. For example, the observer operates the pointing device and moves a cursor so as to set a region of interest (ROI) on the stereoscopic image. Furthermore, the observer performs an operation for displaying a cross-sectional image of the set ROI, and so on. However, the cursor that can be operated by the mouse or the like is moved three-dimensionally in a three-dimensional space (hereinafter, referred to as “stereoscopic image space” in some cases) in which the stereoscopic image is displayed. Therefore, the observer is difficult to grasp a position of the cursor in the depth direction. That is to say, when the mouse or the like is used, the observer has a difficulty in performing various types of operations of setting a region of interest on the stereoscopic image and so on in some cases.

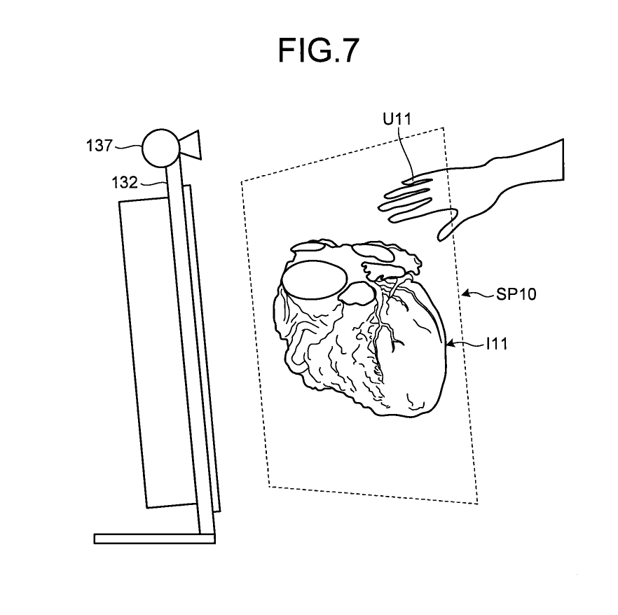

In order to solve the problem, in the first embodiment, an observer can perform various types of operations on a stereoscopic image as if the observer touches the stereoscopic image by a hand directly. This point is described simply with reference to FIG. 7. FIG. 7 is a view for explaining an example of processing by the image processing system 1 in the first embodiment. It is to be noted that a case where a direct operation on a stereoscopic image is realized by the workstation 130 is described as an example, hereinafter.

In the example as illustrated in FIG. 7, the display unit 132 is a stereoscopic display monitor that the workstation 130 has, as described above. As illustrated in FIG. 7, the display unit 132 in the first embodiment displays a stereoscopic image I11 indicating an organ or the like of a subject and displays a frame line indicating an operable region SP10 as a region on which an observer can perform various types of operations on the stereoscopic image I11. With this, the observer can recognize that the observer can perform various types of operations on the stereoscopic image I11 on the operable region SP10. Furthermore, as illustrated in FIG. 7, a camera 137 is installed on the display unit 132. The camera 137 is a three-dimensional (3D) camera that makes it possible to recognize a three-dimensional space stereoscopically. The camera 137 recognizes positional variation of a hand U11 of the observer in the operable region SP10.

Under this configuration, when the hand U11 is located in the operable region SP10, the workstation 130 in the first embodiment detects positional variation of the hand U11 by the camera 137. Then, the workstation 130 determines an operation content on the stereoscopic image I11 based on the positional variation of the hand U11 that has been detected by the camera 137. Thereafter, the workstation 130 performs rendering processing on volume data in accordance with the determined operation content so as to generate a parallax image group newly. Then, the workstation 130 displays the generated parallax image group on the display unit 132. In this manner, the workstation 130 can specify an operation desired by an observer from positional variation of a hand on the operable region SP10 so as to display a stereoscopic image corresponding to the operation. That is to say, according to the first embodiment, an observer can perform various types of operations on a stereoscopic image as if the observer touches the stereoscopic image by a hand directly without using an input unit such as a mouse.

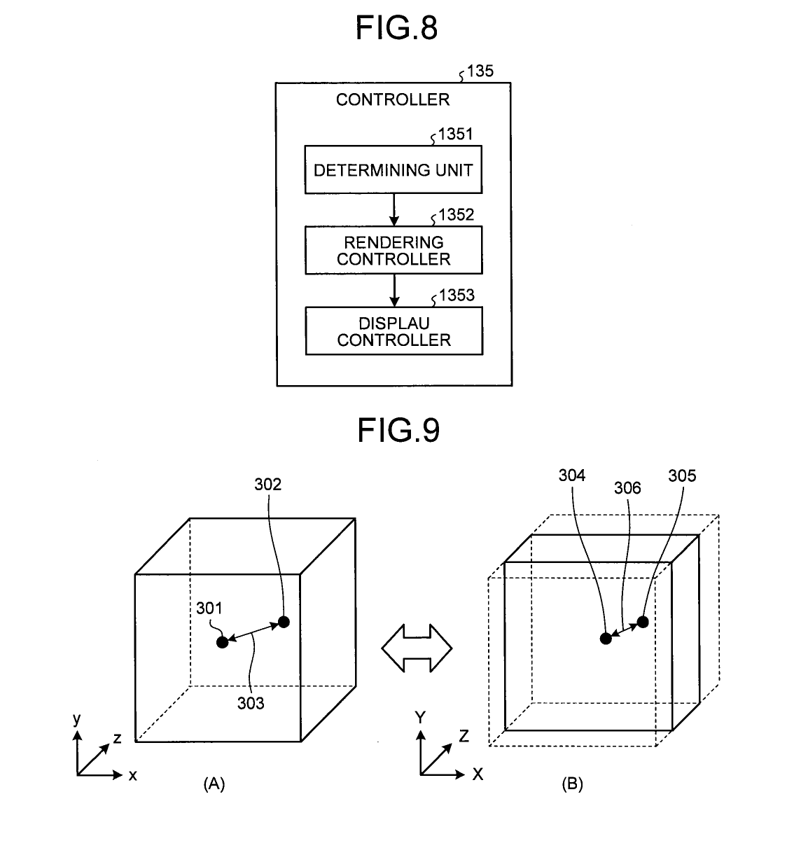

Hereinafter, the workstation 130 in the first embodiment is described in detail. First, the controller 135 that the workstation 130 in the first embodiment has is described with reference to FIG. 8. FIG. 8 is a view for explaining a configuration example of the controller 135 in the first embodiment. As illustrated in FIG. 8, the controller 135 of the workstation 130 includes a determining unit 1351, a rendering controller 1352, and a display controller 1353. Hereinafter, these processors are described simply, and then, a specific example of processing is described.

The determining unit 1351 determines an operation content on a stereoscopic image based on positional variation of a predetermined moving substance located in a stereoscopic image space in which the stereoscopic image is displayed by the display unit 132. To be more specific, when positional variation of the hand U11 of an observer in the operable region SP10 has been detected by the camera 137, the determining unit 1351 in the first embodiment determines an operation content on the stereoscopic image based on the positional variation of the hand U11.

Processing by the determining unit 1351 is described more in detail. First, the storage unit 134 of the workstation 130 in the first embodiment stores therein operations (positional variations) of the hand U11 of an observer in the operable region SP10 and operation contents in a correspondence manner. For example, the storage unit 134 stores therein an operation content of rotating a stereoscopic image, an operation content of enlarging or contracting the stereoscopic image, an operation content of changing opacity of the stereoscopic image, an operation content of cutting the stereoscopic image, an operation content of erasing a part of the stereoscopic image, and the like so as to correspond to predetermined operations (positional variations) of the hand U11. Furthermore, the determining unit 1351 acquires an operation content corresponding to an operation (positional variation) of the hand U11 that has been detected by the camera 137 from the storage unit 134 so as to specify the operation content.

Processing by the camera 137 is described supportively. The camera 137 in the first embodiment includes a predetermined control circuit, and monitors whether a moving substance is present in the operable region SP10. Then, when the moving substance is present, the camera 137 determines whether the moving substance is substantially identical to a predetermined shape (for example, a hand of a person), for example. At this time, when the moving substance has the predetermined shape (for example, a hand of a person), the camera 137 detects time variation of a position of the moving substance in the operable region SP10 so as to detect positional variation of the moving substance (for example, a hand of a person).

The workstation 130 in the first embodiment stores therein correspondence information that makes a position of a stereoscopic image space in which a stereoscopic image is displayed and a position of a real space as the operable region SP10 correspond to each other. To be more specific, the workstation 130 stores therein correspondence information indicating a position in the real space present on a front surface of the display unit 132 at which a coordinate system of the stereoscopic image space is present. The determining unit 1351 identifies a position in the stereoscopic image to which a position of a moving substance (for example, a hand of a person) in the real space that is detected by the camera 137 corresponds based on the correspondence information. Then, the determining unit 1351 performs the above-described processing of specifying an operation content. It is to be noted that the workstation 130 stores therein different correspondence information depending on a display magnification of the display unit 132, a parallax angle as a rendering condition, and the like.

It is to be noted that the processing by the camera 137 is not limited to the example. For example, positional variation of a hand of an observer may be detected in the following manner. That is to say, the observer wears a member (glove or the like) having a shape as a predetermined mark on his (her) own hand and the camera 137 detects positional variation of the member as the mark.

The rendering controller 1352 generates a parallax image group from volume data in corporation with the rendering processor 136. To be more specific, the rendering controller 1352 in the first embodiment controls the rendering processor 136 so as to superimpose images (“stereoscopic images Ic11 to Ic15 of icons” and the like, which will be described later) of tools for performing various types of operations on a stereoscopic image on the parallax image group generated from the volume data. Furthermore, the rendering controller 1352 controls the rendering processor 136 so as to superimpose an image of a frame line and the like indicating an operable region on the parallax image group.

Furthermore, the rendering controller 1352 in the first embodiment controls the rendering processor 136 so as to perform the rendering processing on the volume data as a generation source of the stereoscopic image that is displayed on the display unit 132 in accordance with an operation content determined by the determining unit 1351. At this time, the rendering controller 1352 controls the rendering processor 136 so as to perform the rendering processing based on positional variation of the hand U11 that has been detected by the camera 137. For example, when the operation content is “cutting of the stereoscopic image”, the rendering controller 1352 acquires a cutting position of the volume data from the positional variation of the hand U11 that has been detected by the camera 137 and controls the rendering processor 136 so as to generate a parallax image group obtained by cutting an organ or the like of a subject at the acquired cutting position.

That is to say, the rendering controller 1352 acquires coordinates in a space (hereinafter, referred to as “volume data space” in some cases) in which the volume data is arranged from coordinates at which the hand U11 is located in the stereoscopic image space as in the case of the cutting position in the above-described example. Coordinate systems of the stereoscopic image space and the volume data space are different from each other. Therefore, the rendering controller 1352 acquires the coordinates in the volume data space that correspond to those in the stereoscopic image space using a predetermined coordinate conversion expression.

Hereinafter, a correspondence relationship between the stereoscopic image space and the volume data space is described with reference to FIG. 9. FIG. 9 is a view illustrating an example of the correspondence relationship between the stereoscopic image space and the volume data space. FIG. 9(A) illustrates volume data and FIG. 9(B) illustrates a stereoscopic image that is displayed by the display unit 132. A coordinate 301, a coordinate 302, and a distance 303 in FIG. 9(A) correspond to a coordinate 304, a coordinate 305, and a distance 306 in FIG. 9(B), respectively.

As illustrated in FIG. 9, the coordinate systems of the volume data space in which the volume data is arranged and the stereoscopic image space in which the stereoscopic image is displayed are different from each other. To be more specific, the stereoscopic image as illustrated in FIG. 9(B) is narrower in the depth direction (z direction) in comparison with the volume data as illustrated in FIG. 9(A). In other words, on the stereoscopic image as illustrated in FIG. 9(B), a component of the volume data as illustrated in FIG. 9(A) in the depth direction is compressed to be displayed. In this case, as illustrated in FIG. 9(B), the distance 306 between the coordinate 304 and the coordinate 305 is shorter than the distance 303 between the coordinate 301 and the coordinate 302 as illustrated in FIG. 9(A) by a compressed amount.

Such a correspondence relationship between the coordinates in the stereoscopic image space and the coordinates in the volume data space is determined uniquely with a scale and a view angle of the stereoscopic image, a sight line direction (sight line direction at the time of the rendering or sight line direction at the time of observation of the stereoscopic image), and the like. The correspondence relationship can be expressed in a form of the following Formula 1, for example.

Formula 1=(x1, y1, z1)=F(x2, y2, z2)

In Formula 1, each of “x2”, “y2”, and “z2” indicates a coordinate in the stereoscopic image space. Each of “x1”, “y1”, and “z1” indicates a coordinate in the volume data space. Furthermore, the function “F” is a function that is determined uniquely with the scale and the view angle of the stereoscopic image, the sight line direction, and the like. That is to say, the rendering controller 1352 can acquire the correspondence relationship between the coordinates in the stereoscopic image space and the coordinates in the volume data space using Formula 1. It is to be noted that the function “F” is generated by the rendering controller 1352 every time the scale and the view angle of the stereoscopic image, the sight line direction (sight line direction at the time of the rendering or sight line direction at the time of observation of the stereoscopic image), and the like are changed. For example, affine conversion as indicated in Formula 2 is used as a function “F” of converting rotation, parallel movement, enlargement, and contraction.

x1=a*x2+b*y2+c*z3+d

y1=e*x2+f*y2+g*z3+h

z1=i*x2+j*y2+k*z3+1 Formula 2

(a to l are conversion coefficients)

It is to be noted that in the above-described description, the rendering controller 1352 acquires coordinates in the volume data space based on the function “F”. However, it is not limited to the example. For example, the rendering controller 1352 may acquire coordinates in the volume data space that correspond to the coordinates in the stereoscopic image space in the following manner. That is, the workstation 130 has a coordinate table in which coordinates in the stereoscopic image space and coordinates in the volume data space are made to correspond to each other, and the rendering controller 1352 searches the coordinate table by using the coordinates in the stereoscopic image space as a search key.

Returning back to the description with reference to FIG. 8, the display controller 1353 causes the display unit 132 to display a parallax image group generated by the rendering processor 136. That is to say, the display controller 1353 in the first embodiment causes the display unit 132 to display a stereoscopic image. In addition, the display controller 1353 in the first embodiment causes the display unit 132 to display a stereoscopic image indicating an operable region on which an observer can perform various types of operations on the stereoscopic image, images of tools for performing various types of operations on the stereoscopic image, and the like. Furthermore, when a parallax image group has been generated newly by the rendering processor 136, the display controller 1353 causes the display unit 132 to display the parallax image group.

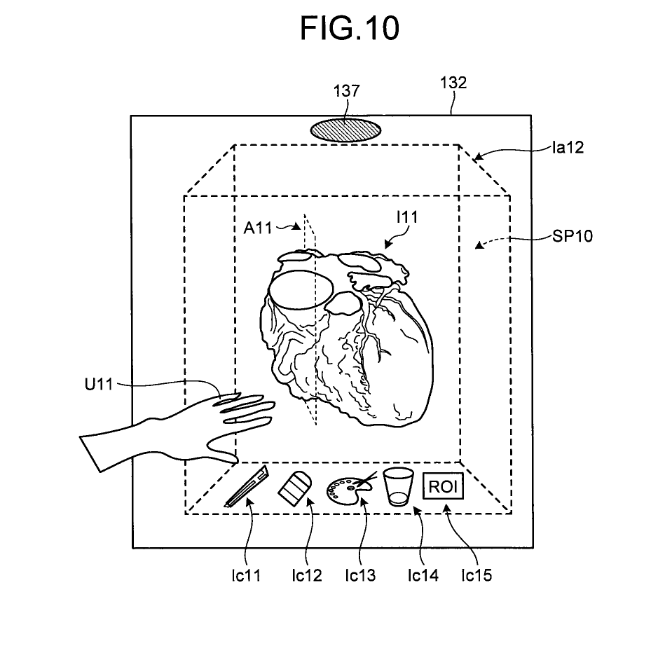

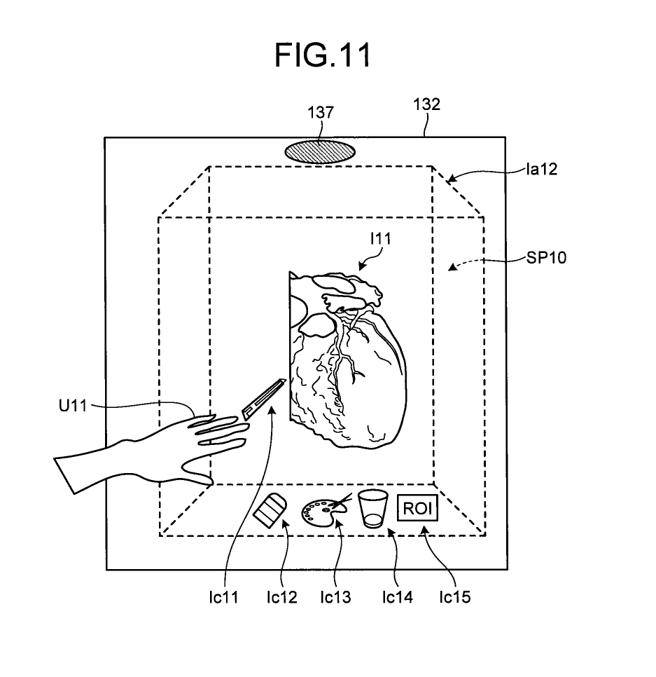

Next, a specific example of processing by the above-described controller 135 is described with reference to FIG. 10 and FIG. 11. FIG. 10 and FIG. 11 are views for explaining an example of processing by the controller 135 in the first embodiment. In FIG. 10 and FIG. 11, cases where the operation contents are “cutting of a stereoscopic image” and “deletion of a stereoscopic image” are described as an example.

In the example as illustrated in FIG. 10, first, the display unit 132 displays a parallax image group generated by the rendering processor 136. With this, the display unit 132 displays the stereoscopic image I11 indicating an organ or the like of a subject, a stereoscopic image Ia12 indicating the operable region SP10 on which various types of operations can be performed, and the stereoscopic images Ic11 to Ic15 of the icons indicating tools with which an observer performs various types of operations on the stereoscopic image I11. It is to be noted that the display unit 132 displays the stereoscopic image Ia12 having a substantially rectangular shape as indicated by a dotted line as an image indicating the operable region SP10.

In other words, the rendering controller 1352 controls the rendering processor 136 to generate a parallax image group in which the stereoscopic image I11 of the subject as illustrated in FIG. 10, the stereoscopic image Ia12 of the operable region SP10, and the stereoscopic images Ic11 to Ic15 of the icons are displayed. It is to be noted that the rendering controller 1352 controls the rendering processor 136 so as to superimpose images corresponding to the stereoscopic images Ic11 to Ic15 of the icons on the parallax image group such that the stereoscopic images Ic11 to Ic15 of the icons are arranged at specific positions in the stereoscopic image space.

The icon Ic11 as illustrated in FIG. 10 is an image indicating a cutting member such as a cutter knife and serves as a tool for cutting the stereoscopic image I11. Furthermore, the icon Ic12 is an image indicating an erasing member such as an eraser and serves as a tool for erasing the stereoscopic image I11 partially. The icon Ic13 is an image indicating a coloring member such as a pallet and serves as a tool for coloring the stereoscopic image I11. The icon Ic14 is an image indicating a deleting member such as a trash and serves as a tool for deleting a part of the stereoscopic image I11. Furthermore, the icon Ic15 is an image indicating a region-of-interest setting member for setting a region of interest.

In the first embodiment, in a state where the above-described various types of stereoscopic images are displayed on the display unit 132, various types of operations are performed on the stereoscopic image I11 by the hand U11 of an observer. For example, when the hand U11 of the observer has been detected to be moved to a display position of the icon Ic11 by the camera 137, the display unit 132 displays a stereoscopic image on which the display position of the icon Ic11 is moved together with the movement of the hand U11 thereafter. To be more specific, the rendering controller 1352 controls the rendering processor 136 so as to superimpose the image of the icon Ic11 on the parallax image group such that the display position of the icon Ic11 is substantially identical to the position of the hand U11 every time the position of the hand U11 that is detected by the camera 137 is moved. Then, the display controller 1353 causes the display unit 132 to display a parallax image group (superimposed image group) that has been generated newly by the rendering processor 136. This provides a stereoscopic image on which the position of the hand U11 is substantially identical to the display position of the icon Ic11 to the observer.

In the example as illustrated in FIG. 10, it is assumed that the hand U11 has been moved by the observer and the icon Ic11 has passed through a surface A11 in the stereoscopic image I11. In such a case, the determining unit 1351 determines that an operation of cutting the stereoscopic image I11 along the surface A11 has been performed based on a fact that the icon Ic11 is the cutting member. At this time, the determining unit 1351 acquires positional information of the hand U11 on the operable region SP10 from the camera 137 so as to identify a position of the surface A11 through which the icon Ic11 passes in the stereoscopic image I11. Then, the determining unit 1351 notifies the rendering controller 1352 of the identified position of the surface A11 in the stereoscopic image I11. The rendering controller 1352 acquires a region in the volume data space that corresponds to the surface A11 using the above-described function “F”. Then, the rendering controller 1352 changes voxel values of voxels corresponding to the surface A11 among a voxel group constituting the volume data to a voxel value indicating the air or the like, for example. Thereafter, the rendering controller 1352 controls the rendering processor 136 so as to perform the rendering processing on the volume data. With this, the rendering processor 136 can generate a parallax image group for displaying a stereoscopic image I11 cut along the surface A11.

In addition, it is assumed that the hand U11 has been moved by the observer and an operation of moving a left portion (left side with respect to the surface A11) of the cut stereoscopic image I11 to the icon Ic14 has been performed. The left portion of the stereoscopic image I11 may be moved together with the hand U11 or may not be moved together with the hand U11. Note that when the left portion of the stereoscopic image I11 is moved together with the hand U11, the rendering controller 1352 controls the rendering processor 136 so as to perform the rendering processing after arranging voxels corresponding to the left portion of the stereoscopic image I11 among voxels in the volume data at a position of the hand U11 such that the position of the hand U11 and the position of the left portion of the stereoscopic image I11 are substantially identical to each other.

In such a case, the determining unit 1351 determines that an operation of deleting the left portion of the stereoscopic image I11 has been performed based on a fact that the icon Ic14 is the deleting member. The rendering controller 1352 acquires a region in the volume data space that corresponds to the left portion of the stereoscopic image I11 using the above-described function “F”. Then, the rendering controller 1352 controls the rendering processor 136 so as to perform the rendering processing while excluding the voxels corresponding to the left portion among the voxel group constituting the volume data from a rendering target. With this, the rendering processor 136 can generate a parallax image group for displaying a stereoscopic image I11 from which the left portion has been deleted.

The rendering processor 136 manages information (referred to as “rendering target flag” in this example) indicating whether a voxel is set to a rendering target for each voxel constituting the volume data. The rendering processor 136 performs the rendering processing after the rendering target flags of the voxels corresponding to the left portion of the stereoscopic image I11 have been updated to “rendering non-targets”. With this, the rendering processor 136 can generate a parallax image group for displaying a stereoscopic image I11 from which the left portion has been deleted. It is to be noted that the rendering processor 136 can generate the parallax image group from which the left portion has been deleted by setting opacity of the voxels of which rendering target flags are “rendering non-targets” to “0%”.

The display controller 1353 causes the display unit 132 to display the parallax image group that has been generated in the above manner. With this, the display unit 132 can display the stereoscopic image I11 from which the left portion has been deleted as illustrated in the example as illustrated in FIG. 11. The stereoscopic image I11 as illustrated in FIG. 11 is constituted by a parallax image group that has been generated when the rendering processing is performed by the rendering processor 136 again. Accordingly, the observer comes around and observes the stereoscopic image I11 as illustrated in FIG. 11 so as to observe a cross-sectional image of a portion cut by the icon Ic11.

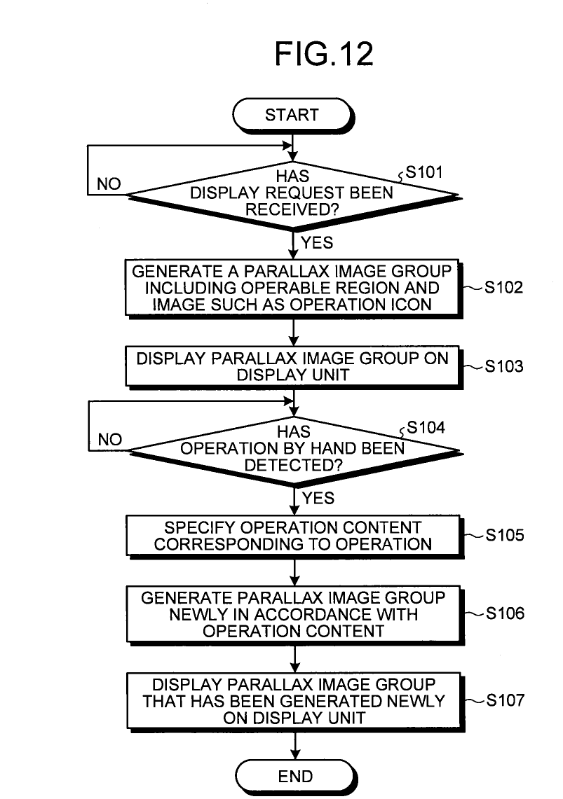

Next, an example of a processing flow by the workstation 130 in the first embodiment is illustrated with reference to FIG. 12. FIG. 12 is a flowchart illustrating an example of a processing flow by the workstation 130 in the first embodiment.

As illustrated in FIG. 12, the controller 135 of the workstation 130 determines whether a display request of a stereoscopic image has been received from the terminal device 140 (S101). When the display request has not been received (No at S101), the workstation 130 stands by until a display request is received.

On the other hand, when the display request has been received (Yes at S101), the rendering controller 1352 of the workstation 130 controls the rendering processor 136 so as to generate a parallax image group including an operable region and images such as icons for operations (S102).

Then, the display controller 1353 of the workstation 130 causes the display unit 132 to display the parallax image group that has been generated by the rendering processor 136 (S103). With this, the display unit 132 displays a stereoscopic image indicating an organ or the like of a subject, a stereoscopic image indicating an operable region on which various types of operations can be performed, and stereoscopic images of icons indicating tools for performing various types of operations, as illustrated in FIG. 10.

Subsequently, the determining unit 1351 of the workstation 130 monitors whether positional variation of a hand of an observer in the operable region has been detected by the camera 137 (S104). When the positional variation of the hand has not been detected (No at S104), the determining unit 1351 stands by until positional variation of the hand is detected by the camera 137.

On the other hand, when the positional variation of the hand has been detected by the camera 137 (Yes at S104), the determining unit 1351 specifies an operation content corresponding to the positional variation (S105). Then, the rendering controller 1352 controls the rendering processor 136 so as to perform rendering processing in accordance with the operation content determined by the determining unit 1351. With this, the rendering processor 136 generates a parallax image group newly (S106). Then, the display controller 1353 causes the display unit 132 to display the parallax image group that has been generated newly by the rendering processor 136 (S107).

As described above, according to the first embodiment, an observer can perform various types of operations on a stereoscopic image sensuously.

### Second Embodiment

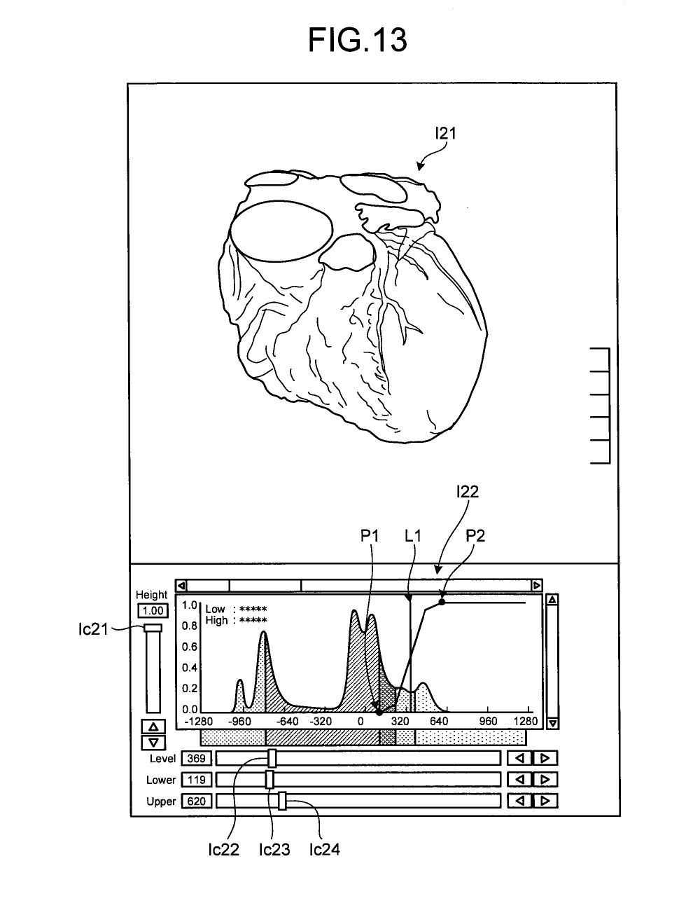

The above-described embodiment can be also varied into another embodiment. In the second embodiment, a modification of the above-described embodiment is described. It is to be noted that FIG. 13 to FIG. 15 as will be described below are views for explaining modifications of the first embodiment.

### Operation Content

In the above-described embodiment, the cases where the operation contents are “cutting of a stereoscopic image” and “deletion of a stereoscopic image” have been described as examples with reference to FIG. 10 and FIG. 11. However, the operation contents are not limited thereto. One example of other operation contents that are received by the workstation 130 is described in the following items 1 to 6.

1. Erasure of Part Of Stereoscopic Image

For example, in the example as illustrated in FIG. 10, it is assumed that the hand U11 of the observer has been moved to a display position of the icon Ic12 as the erasing member, and then, has been moved to a predetermined position (assumed to be a position at which a bone is displayed in this example) in the stereoscopic image I11. In such a case, the determining unit 1351 determines that an operation of erasing the bone as a part of the stereoscopic image I11 has been performed. Then, the rendering controller 1352 controls the rendering processor 136 so as to perform the rendering processing after updating rendering target flags of voxels indicating the bone among the voxel group constituting the volume data to “rendering non-targets”. With this, the workstation 130 can display a stereoscopic image I11 from which the bone has been erased.

2. Changing of Display Method of Stereoscopic Image

Furthermore, in the example as illustrated in FIG. 10, it is assumed that the hand U11 of the observer has been moved to a display position of the icon Ic13 as the coloring member, and then, has been moved to a predetermined position (assumed to be a position at which a blood vessel is displayed in this example) in the stereoscopic image I11. In such a case, the determining unit 1351 determines that an operation of coloring the blood vessel as a part of the stereoscopic image I11 has been performed. Then, the rendering controller 1352 controls the rendering processor 136 so as to perform rendering processing after updating pixel values of voxels indicating the blood vessel among the voxel group constituting the volume data to values corresponding to a color specified by the observer. With this, the workstation 130 can display a stereoscopic image I11 including the blood vessel that has been added with the color specified by the observer. It is to be noted that paints or the like of a plurality of colors are displayed on the icon Ic13 and the determining unit 1351 can specify a color to be added to the stereoscopic image in accordance with a color of the paint that the observer touches.

Alternatively, the workstation 130 may display a stereoscopic image of an icon indicating an adjusting member such as a control strip in the operable region, for example. Then, when an operation of moving a tab or the like on the control strip to right-left sides or up-down sides has been performed by the observer, the determining unit 1351 determines that an operation of changing opacity of the stereoscopic image has been performed. In this case, the rendering controller 1352 controls the rendering processor 136 so as to perform the rendering processing while changing the opacity in accordance with a movement amount of the tab moved by the observer, for example. Furthermore, the workstation 130 may change opacity of a predetermined region only when the predetermined region in the stereoscopic image has been specified by the observer and the operation of moving the tab or the like on the above-described control strip has been performed.

An example of the operation of changing the opacity is described with reference to FIG. 13. In the example as illustrated in FIG. 13, the display unit 132 displays a parallax image group that has been generated by the rendering processor 136. With this, the display unit 132 displays a stereoscopic image I21 of an organ or the like of a subject, an image I22 indicating opacity of the stereoscopic image I21, images Ic21 to Ic24 of icons indicating control stripes and tabs with which the opacity is changed by the observer, and the like. In other words, the rendering controller 1352 causes the rendering processor 136 to generate a parallax image group in which the stereoscopic image I21 indicating the organ or the like of the subject, the image I22 indicating the opacity, and the images Ic21 to Ic24 of the icons as illustrated in FIG. 13 are displayed. Note that the rendering controller 1352 controls the rendering processor 136 so as to superimpose the images corresponding to the stereoscopic images Ic21 to Ic24 on the parallax image group such that the images Ic21 to Ic24 of the icons are arranged at specific positions in the stereoscopic image space.

In the image I22 as illustrated in FIG. 13, a horizontal axis indicates a CT value and a vertical axis indicates the opacity. To be more specific, the image I22 indicates that the opacity on a region of which CT value is smaller than that at a point P1 in the stereoscopic image I21 is “0%” and the region is not displayed as a stereoscopic image. The image I22 indicates that the opacity on a region of which CT value is larger than that at a point P2 in the stereoscopic image I21 is “100%”, the region is displayed as a stereoscopic image, and a region behind the region is not displayed out. Furthermore, the image I22 indicates that the opacity on a region of which CT value is in a range of that at the point P1 to that at the point P2 in the stereoscopic image I22 is in a range of “0%” to “100%”. That is to say, the region of which CT value is in the range of that at the point P1 to that at the point P2 is displayed to be translucent and is a region in which as the CT value is closer to that at the point P1, opacity is increased. It is to be noted that a straight line L1 in the image I22 indicates a CT value at a middle point of the point P1 and the point P2.

Furthermore, in the example as illustrated in FIG. 13, the icon Ic21 indicates a control stripe and a tab for changing opacity of the entire stereoscopic image I21. The icon Ic22 indicates a control stripe and a tab for determining a range of the CT value for which the opacity is set. To be more specific, the straight line L1 as indicated in the image I22 can be moved to the right-left sides together with the point P1 and the point P2 by moving the tab as indicated on the icon Ic22 to the right-left sides. Furthermore, the icon Ic23 indicates a control stripe and a tab for determining a range of the CT value in which the opacity is “0%”. To be more specific, the point P1 as indicated in the image I22 can be moved to the right-left sides by moving the tab as indicated on the icon Ic23 to the right-left sides. In addition, the icon Ic24 indicates a control stripe and a tab for determining a range of the CT value in which the opacity is “100%”. To be more specific, the point P2 as indicated in the image I22 can be moved to the right-left sides by moving the tab as indicated on the icon Ic24 to the right-left sides.

In such a state where the stereoscopic image I21, the image I22, the icons Ic21 to Ic24, and the like are displayed on the display unit 132, for example, when the hand U11 of the observer has been moved to the display positions of the icons Ic21 to Ic24, and then, movement of various tabs to the right-left sides has been detected by the camera 137, the rendering controller 1352 controls the rendering processor 136 so as to perform the rendering processing after varying the opacity in accordance with the movement of the hand U11 that has been detected by the camera 137. With this, the rendering processor 136 can generate a parallax image group of which opacity has been varied in accordance with the movement of the hand U11.

3. Rotation of Stereoscopic Image

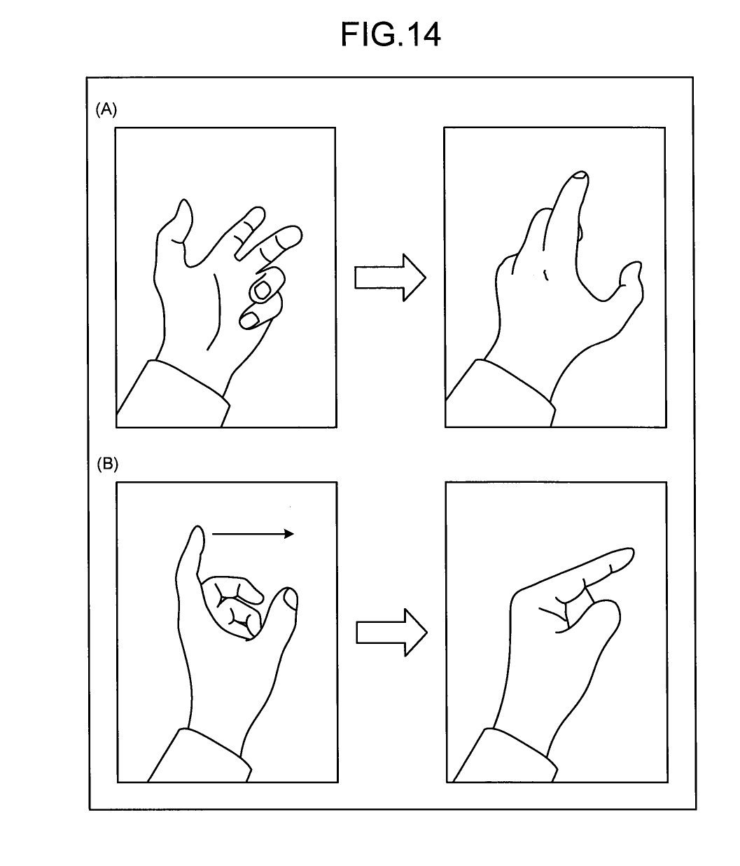

Furthermore, for example, when positional variation of a hand as illustrated in FIG. 14 has been detected by the camera 137, the determining unit 1351 determines that an operation of rotating a stereoscopic image has been performed. In such a case, the rendering controller 1352 controls the rendering processor 136 so as to perform the rendering processing while changing a viewpoint position and a sight line direction. With this, a parallax image group for displaying a rotated stereoscopic image can be generated.

It is to be noted that setting that can be adjusted by control stripes as described above is not limited to opacity. For example, when a control stripe of a stereoscopic image has been operated by an observer, the workstation 130 may adjust an enlargement factor or a contraction factor of the stereoscopic image, a parallax angle of a parallax image group constituting the stereoscopic image, or the like.

4. Setting of Region Of Interest

Furthermore, when an operation that an observer touches a predetermined region in a stereoscopic image has been performed, the determining unit 1351 may determine that an operation of setting the predetermined region to a region of interest has been performed. For example, in the example as illustrated in FIG. 10, it is assumed that the hand U11 of the observer has been moved to a display position of the icon Ic15 as the region-of-interest setting member, and then, has been moved to a predetermined position (assumed to be a position at which a blood vessel is displayed in this example) in the stereoscopic image I11. In such a case, the determining unit 1351 determines that an operation of setting the blood vessel as a part of the stereoscopic image I11 to the region of interest has been performed. To be more specific, the determining unit 1351 identifies a position (position at which the blood vessel is displayed in this example) that is touched by the hand U11 in the stereoscopic image I11. Then, the determining unit 1351 performs segmentation processing using a pattern matching method using a shape template, a region growing method, or the like. With this, the determining unit 1351 extracts the organ (blood vessel in this example) included in the position specified by the observer to set the extracted organ to the region of interest.

5. Operation Method

In addition, in the examples as illustrated in FIG. 10 and FIG. 11, various types of operations are performed on the stereoscopic image by one hand. However, the observer may perform various types of operations on the stereoscopic image by both hands. For example, when an operation of wrapping a predetermined region by palms of both hands has been performed, the determining unit 1351 may determine that the operation of setting the predetermined region to a region of interest has been performed.

### Segmentation

Furthermore, in the above-described embodiment, when the operation of touching a predetermined region in a stereoscopic image by a hand has been performed by an observer or when the operation of wrapping a predetermined region by palms of both hands has been performed as described in the above-described “5. Operation Method”, the determining unit 1351 may determine that an operation of extracting an organ (blood vessel, bone, heart, liver, or the like) included in the predetermined region has been performed. In such a case, the rendering controller 1352 controls the rendering processor 136 so as to extract the organ (blood vessel, bone, heart, liver, or the like) included in the predetermined region specified by the observer by performing segmentation processing using a pattern matching method using a shape template, a region growing method, or the like. Then, the rendering processor 136 may perform the rendering processing on volume data of the extracted organ so as to generate a parallax image group indicating the organ only. Alternatively, the rendering processor 136 may perform the rendering processing on volume data in which data of the extracted organ is excluded so as to generate a parallax image group indicating a portion in which the extracted organ is excluded. With this, even when a position cannot be specified in the operable region with high accuracy, the observer can cause the display unit 132 to display a stereoscopic image of a desired organ only, a stereoscopic image of a site in which only a desired organ is excluded, or the like.

Operation Device

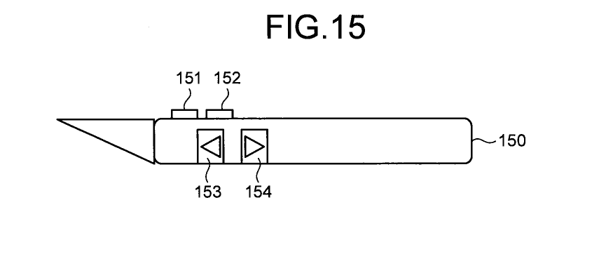

Furthermore, in the above-described embodiment, various types of operations on a stereoscopic image are performed by a hand of an observer, as an example. To be more specific, an operation content on the stereoscopic image is determined by detecting positional variation of the hand of the observer by the camera 137. However, various types of operations on the stereoscopic image may not be performed by the hand of the observer. For example, the observer may perform various types of operations on the stereoscopic image using an operation device as illustrated in FIG. 15. Various types of buttons 151 to 154 are provided on an operation device 150 as illustrated in FIG. 15. The buttons 151 and 152 receive changing of any of rotation, enlargement, contraction, cutting, deletion, coloring, opacity, and the like, for example. The buttons 153 and 154 receive setting of a rotation amount, an enlargement factor, a contraction factor, opacity, and the like of the stereoscopic image, for example. The operation device 150 may have a position sensor that makes it possible to acquire a position thereof in an operable region, and transmit positional information in the operable region that has been acquired by the position sensor to the workstation 130. In such a case, the display unit 132 may not have the camera 137.

Processing Entity

In the above-described embodiment, the workstation 130 receives various types of operations on a stereoscopic image, as an example. However, the embodiment is not limited thereto. For example, the terminal device 140 may receive various types of operations on the stereoscopic image. In such a case, the terminal device 140 has functions that are equivalent to the determining unit 1351 and the display controller 1353 as illustrated in FIG. 8. Furthermore, the terminal device 140 displays a parallax image group generated by the workstation 130 on a stereoscopic display monitor that the terminal device 140 has. When various types of operations on a stereoscopic image that is displayed on the stereoscopic display monitor have been received, the terminal device 140 transmits operation contents thereof to the workstation 130 so as to acquire the parallax image group in accordance with the operation contents from the workstation 130.

In addition, in the above example, the terminal device 140 may have a function that is equivalent to the rendering controller 1352 as illustrated in FIG. 8. In such a case, volume data is acquired from the terminal device 140 and the processing that is the same as that performed by each processor as illustrated in FIG. 8 is performed on the acquired volume data.

In the above-described embodiment, the medical image diagnostic device 110 and the workstation 130 may be integrated with each other. That is to say, the medical image diagnostic device 110 may have a function that is equivalent to the controller 135.

### System Configuration

Furthermore, all of or a part of processing that have been described to be performed automatically among the pieces of processing as described in the above embodiments can be performed manually. Alternatively, all of or a part of processing that have been described to be performed manually among the pieces of processing as described in the above embodiment can be performed automatically by a known method. In addition, information including processing procedures, control procedures, specific names, and various data and parameters as described in the above-described document and drawings can be changed arbitrarily unless otherwise specified.

The constituent components of the devices as illustrated in the drawings are conceptual functionally and are not necessarily required to be configured as illustrated in the drawings physically. That is to say, specific forms of disintegration and integration of the devices are not limited to those as illustrated in the drawings, and all of or a part of them can be configured to be disintegrated or integrated functionally or physically based on an arbitrary unit depending on various loads and usage conditions. For example, the controller 135 of the workstation 130 may be connected through a network as an external device of the workstation 130.

Computer Program

Furthermore, a computer program in which processing to be executed by the workstation 130 in the above-described embodiments is described with language that can be executed by a computer can be created. In this case, the computer executes the program so as to obtain effects as those obtained in the above-described embodiments. Furthermore, the processing that is the same as that in the above embodiment may be executed by recording the program in a computer readable recording medium and causing the computer to load and execute the program recorded in the recording medium. For example, the program is recorded in a hard disk, a flexible disk (FD), a compact disc read only memory (CD-ROM), a magnetooptic disc (MO), a digital versatile disc (DVD), a Blu-ray (registered trademark) Disc, or the like. Furthermore, the program can be distributed through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing system comprising:
a stereoscopic display device configured to display a stereoscopic image that is capable of being viewed stereoscopically using a parallax image group generated from volume data as three-dimensional medical image data;
a determining unit configured to identify positional variation of a predetermined moving substance in a stereoscopic image space as a space in which the stereoscopic image is displayed by the stereoscopic display device from positional variation of the moving substance in a real space in which a coordinate system of the stereoscopic image space is present and determines an operation content on the stereoscopic image based on the identified positional variation;
a rendering processor configured to perform rendering processing on the volume data in accordance with the operation content determined by the determining unit to generate a parallax image group newly; and
a display controller configured to cause the stereoscopic display device to display the parallax image group that has been generated newly by the rendering processor.

2. The image processing system according to claim 1, wherein the rendering processor converts positional variation of the moving substance in the stereoscopic image space to positional variation in space coordinates of the volume data, and changes a rendering condition as a condition of rendering processing on the volume data in accordance with the converted positional variation of the moving substance.

3. The image processing system according to claim 1, wherein
the determining unit determines that an operation of extracting a predetermined organ from a predetermined region of the stereoscopic image has been performed based on the positional variation of the moving substance in the stereoscopic image space, and
the rendering processor extracts volume data corresponding to the organ of a subject that is included in the predetermined region of the stereoscopic image from the volume data and performs rendering processing on the extracted volume data so as to generate a parallax image group newly.

4. The image processing system according to claim 1, wherein
the determining unit determines that an operation of excluding a predetermined organ from a predetermined region of the stereoscopic image based on the positional variation of the moving substance in the stereoscopic image space, and
the rendering processor extracts volume data other than volume data corresponding to the organ of a subject that is included in the predetermined region of the stereoscopic image from the volume data and performs rendering processing on the extracted volume data so as to generate a parallax image group newly.

5. The image processing system according to claim 1, wherein
the rendering processor superimposes an image of a frame line that indicates an operable region as a three-dimensional region on which an operation can be performed on the stereoscopic image on the parallax image group, and
the display controller causes the stereoscopic display device to display the frame line that indicates the operable region together with the stereoscopic image.

6. An image processing device comprising:
a stereoscopic display device configured to display a stereoscopic image that is capable of being viewed stereoscopically using a parallax image group generated from volume data as three-dimensional medical image data;
a determining unit configured to identify positional variation of a predetermined moving substance in a stereoscopic image space as a space in which the stereoscopic image is displayed by the stereoscopic display device from positional variation of the moving substance in a real space in which a coordinate system of the stereoscopic image space is present and determines an operation content on the stereoscopic image based on the identified positional variation;
a rendering processor configured to perform rendering processing on the volume data in accordance with the operation content determined by the determining unit to generate a parallax image group newly; and
a display controller configured to cause the stereoscopic display device to display the parallax image group that has been generated newly by the rendering processor.

7. An image processing method that is executed by an image processing system including a stereoscopic display device configured to display a stereoscopic image that is capable of being viewed stereoscopically using a parallax image group generated from volume data as three-dimensional medical image data, the image processing method comprising:
identifying positional variation of a predetermined moving substance in a stereoscopic image space as a space in which the stereoscopic image is displayed by the stereoscopic display device from positional variation of the moving substance in a real space in which a coordinate system of the stereoscopic image space is present and determining an operation content on the stereoscopic image based on the identified positional variation; and
performing rendering processing on the volume data in accordance with the determined operation content to generate a parallax image group newly; and
causing the stereoscopic display device to display the parallax image group that has been generated newly.

8. A medical image diagnostic device comprising:
a stereoscopic display device configured to display a stereoscopic image that is capable of being viewed stereoscopically using a parallax image group generated from volume data as three-dimensional medical image data;
a determining unit configured to identify positional variation of a predetermined moving substance in a stereoscopic image space as a space in which the stereoscopic image is displayed by the stereoscopic display device from positional variation of the moving substance in a real space in which a coordinate system of the stereoscopic image space is present and determine an operation content on the stereoscopic image based on the identified positional variation;
a rendering processor configured to perform rendering processing on the volume data in accordance with the operation content determined by the determining unit to generate a parallax image group newly; and
a display controller configured to cause the stereoscopic display device to display the parallax image group that has been generated newly by the rendering processor.
